(19) United States
(12) Patent Application Publication
(10) Pub. No.: US 2024/0078622 A1
(43) Pub. Date: Mar. 7, 2024

(54) Platform for Generating, Negotiating, and Monitoring Agreements

(71) Applicant: Nodal Solutions, Denver, CO (US)

(72) Inventors: Ryan Arney, Denver, CO (US); Todd Siegler, Evergreen, CO (US)

(21) Appl. No.: 18/243,317

(22) Filed: Sep. 7, 2023

Related U.S. Application Data
(60) Provisional application No. 63/374,863, filed on Sep. 7, 2022.

(51) Int. Cl. G06Q 50/18

(52) U.S. Cl. CPC G06Q 50/182; G06Q 50/188

(57) ABSTRACT

A system (100) (e.g., cloud-based) is described for drafting, negotiating, analyzing, and managing agreements such as NDAs. The system (100) includes a platform (104) that can be accessed by a number of parties (101-103). Individual parties (101-103) may access the platform (104) to build a playbook, to generate an NDA, analyze a target NDA, or to monitor existing NDAs, among other things. Similarly, multiple parties (101-103) may access the platform (104) to negotiate a new NDA. Such parties may have an existing playbook or may be invited to develop a playbook in connection with negotiations.

### CROSS-REFERENCE TO RELATED APPLICATION

This application claims priority to U.S. Provisional Patent Application No. 63/374,863 entitled “Platform for Generating, Negotiating, and Monitoring Agreements,” filed Sep. 7, 2022, the contents of which are incorporated herein as if set forth in full and priority is claimed to the full extent allowable under U.S. law and regulations.

### FIELD OF THE INVENTION

The present invention relates to computer-based tools for managing documents and, in particular, to a platform for generating, negotiating, analyzing, and monitoring agreements such as nondisclosure agreements.

### BACKGROUND

Certain types of contracts or agreements are widely used in commercial and private matters. For example, nondisclosure agreements (NDAs) are used in a variety of contexts to protect proprietary or sensitive information. Some examples of these contexts include use of NDAs 1) to protect business information in connection with fundraising, mergers and acquisitions, and other business activities; 2) to protect technology in connection with joint development, contract manufacturing, and supply/distribution relationships; and 3) to protect private information in relation to personal or business relationships. In any of these contexts, the NDA generally defines the protected information, defines the terms for protection of the information, and (typically) defines certain exceptions or other terms for expiration of or release from obligations under the NDA.

Because NDAs are widely used in many contexts, a variety of types of provisions have become customary or expected and experienced practitioners can recognize certain versions of those provisions that may be more favorable to one party or another in a given context. Such provisions include contract sections or paragraphs, terms, clauses, language or words. Some examples of considerations in relation to drafting and negotiating NDAs include whether the NDA is a one-way or two-way (or multiple-way) NDA, what is the term of the agreement, what are the restraints on use or disclosure of the protected information, what obligations survive termination of the agreement, what laws and forums govern the agreement or disputes thereunder, are there any ancillary obligations such as non-solicitation of employees, and what will be the disposition of materials containing protected information upon termination. In some cases, certain provisions may be painstakingly negotiated.

In certain businesses where NDAs are frequently negotiated, a substantial amount of time and resources may be devoted to drafting, negotiating, tracking negotiation status, and monitoring obligations under NDAs. This may involve attorneys, officers, managers, and administrative resources. Moreover, this may be true even though a given business may enter into generally similar NDAs in similar contexts on a regular basis. Substantial efficiencies could be achieved if the resources dedicated to those efforts could be reduced without compromising, or even while enhancing, the end-product of such efforts.

### SUMMARY OF THE INVENTION

The present invention is directed to a platform (e.g., cloud-based) for drafting, negotiating, and managing agreements such as NDAs. In connection with the agreements, the platform develops a digital playbook embodying such party's preferences concerning various agreement provisions. When parties desire to enter an agreement, the platform can compare two parties' playbooks to quickly generate a proposed agreement with recognizable terms that the parties designated as acceptable in their playbooks or, if only one party has a playbook, the platform can match the other party's proposed agreement edits against the first party's playbook to determine acceptability of such edits. In this manner, the process of entering agreements is expedited, the time spent negotiating agreements is reduced, and the parties have confidence that the terms are acceptable (e.g., in accordance with preferences or policies) and well-understood. The platform can also monitor the progress of negotiations and the status of agreements as well as provide alerts concerning required actions by agreement parties and verify compliance with their agreements.

In accordance with one aspect of the present invention, a system and associated functionality (“utility”) are provided for building a playbook regarding a party's preferences in relation to agreement provisions, such as provisions of an NDA. The utility involves operating a computer-based platform for receiving input information for a party and converting the input information into one or more playbooks, where each of the playbooks includes structured data. For example, different playbooks may be provided for different types of NDAs (e.g., one-way, two-way or multi-way) or different contexts (e.g., disclosing business information to a potential investor or disclosing technical information to a joint development partner). The data is structured according to a schema defining preference information concerning two or more agreement provision options for each of multiple agreement provisions e.g., 50 or more provisions, each with two or more options. One of the playbooks can then be used in developing an agreement for the party.

The input information may be received in a variety of ways. For example, the party may complete a survey where the party provides preference information concerning different options for a given provision, such as by ranking the options. The party may also identify certain options as being acceptable or unacceptable. Moreover, these functions may be combined such that, for example, a party identifies certain provision options as being unacceptable and ranks the remaining acceptable options by preference or of even acceptability. Alternatively, the input information may be inferred from documents provided by a party, e.g., standard or model NDA agreements of the party. In this regard, the system may receive one or more agreement documents uploaded by a party or otherwise accessed. The agreement documents can then be processed to generate structured data and elements of the structured data can be mapped to the noted schema to yield preference information concerning provision options for the multiple agreement provisions. For example, based on analysis of standard or model NDA agreements of a party, the system may identify certain provision options as being acceptable or even preferred by the party.

The playbooks can then be used in a variety of ways. As will be described in more detail below, a playbook can be used to match to a counterparty's playbook in connection with a contract negotiation or to receive and assess for acceptability edits from a counterparty during contract negotiations, or the playbook can be used to extract information concerning actions and deadlines in connection with contract monitoring. The playbooks can also be used in drafting, reviewing, and editing an agreement received outside the platform. In this regard, a party may access a graphical representation of a playbook including a list of contract provisions, rankings, and associated ranking information. Provision options can then be imported into a draft agreement by a drag-and-drop, radio button, or similar process. The resulting added or revised provisions may be automatically red-lined to show revisions in connection with such processes. In this manner, a new agreement can be quickly drafted, or an existing agreement draft can be quickly edited, in accordance with party preferences or policies.

In accordance with another aspect of the present invention, a utility is provided for use in negotiating an agreement, such as an NDA. The utility involves operating a computer-based platform for receiving input information for at least one party to the agreement and converting the input information into one or more playbooks for that party or parties. Each of playbooks includes structured data according to a schema defining preference information concerning two or more provision options for each of multiple agreement provisions. The platform is further operative for identifying at least first and second parties for an agreement negotiation and accessing a first playbook associated with the first party and second NDA information, that may or may not be second playbook, of the second party. Matching logic is then executed to compare, on a provision-by-provision basis using the schema, the first playbook and second agreement information to generate a proposed agreement. The matching logic may include first logic for identifying matching provisions of the first playbook and second agreement information and second logic for resolving a difference between the first playbook and second agreement information for multiple agreement provisions. For example, the matching logic may include at least one of machine learning logic and an algorithm (among other possibilities) for resolving differences.

The platform thereby generates a proposed agreement including terms that are likely to be acceptable to all parties. Nonetheless, individual parties may access the platform to make proposed revisions, for example, by directly editing the language of one or more provisions or by proposing replacement of one or more provisions with an alternative provision option from the platform, among other options. The platform can then notify the other party or parties of the proposed revisions and automatically generate a red-line version showing the proposed changes for review by the other party(ies). The other party(ies) can accept the proposed changes, reject the proposed changes, or make a counter proposal in similar fashion. Once all differences have thus been resolved, the parties can sign the finalized agreement, e.g., via an electronic signature application provided via the platform or otherwise.

In accordance with a further aspect of the present invention, a utility is provided for monitoring one or more agreements for a party and providing reports, e.g., via a dashboard or text or email alerts. The utility involves obtaining at least one agreement, performing an analysis of the agreement in relation to a schema defining one or more attributes concerning provision options for each of multiple agreement provisions and values relating to the options, identifying one or more requirements of the party under the agreement and an associated timeline, and providing a report concerning the requirements. For example, the analysis may indicate a date on which an agreement is terminated, a deadline for returning or destroying documents containing protected information under the agreement, or expiration of a non-solicitation provision. The platform may also monitor the status of NDAs that have not yet been executed, for example, to indicate a status of “pending” or “in-negotiation,” or may track a deadline or proposed date for approving the agreement text or providing revisions. The report may be provided in various ways such as, for example, providing an alert or reminder, for example, via text or email, or providing a dashboard that shows the status of various agreements. The platform may also be operative for verifying compliance with agreement provisions such as by, for example, accessing a data room of a party to verify removal of documents including protected information.

In accordance with a still further aspect of the present invention, a utility is provided for analyzing an agreement, e.g., a third-party NDA uploaded to a platform for analysis by a first party. The utility involves: obtaining industry data concerning agreements and provisions thereof; receiving target agreement information (e.g., an NDA or portion thereof for analysis or a URL or other identifying information for accessing an NDA or portion thereof); generating target structured data representative of the target agreement information; performing a comparison of the target structured data to the industry data; generating a report based on said comparison; and transmitting the report to a recipient. For example, the report may be transmitted to a party who uploaded a third-party NDA to the platform for analysis. The industry data may be based on analysis of many agreement provisions and may be organized by industry, context, and other factors. In this manner, parties can quickly obtain analytics concerning proposed agreements including favorability ratings and relation to industry standards.

### BRIEF DESCRIPTION OF THE DRAWINGS

For a more complete understanding of the present invention, and further advantages thereof, reference is now made to the following detailed description, taken in conjunction with the drawings, in which:

FIG. 1 is a schematic diagram of an NDA generating, negotiating, analysis, and monitoring system in accordance with the present invention;

FIG. 2 is a flowchart of a process for building playbooks and drafting NDAs in accordance with the present invention;

FIG. 3 is a flowchart of a process for negotiating NDAs in accordance with the present invention;

FIG. 4 is a flowchart illustrating a process for NDAs in accordance with the present invention;

FIG. 5 is a screenshot showing an example of a user interface used in connection with building a playbook in accordance with the present invention;

FIG. 6 is a screenshot showing an example of a user interface depicting a playbook in accordance with the present invention;

FIG. 7 is a screenshot showing an example of a user interface that can be used to select and rank provision options in accordance with the present invention;

FIG. 8 is a screenshot showing a further example of a user interface that can be used in connection with building a playbook in accordance with the present invention;

FIG. 9 is a screenshot showing an example of a user interface that may be provided in connection with initiating an NDA negotiation in accordance with the present invention; and

FIG. 10 is a screenshot showing an example of a user interface for displaying a dashboard showing NDA status in accordance with the present invention.

### DETAILED DESCRIPTION

The present invention relates to a system and associated functionality for generating, negotiating, analyzing, and monitoring agreements, including NDAs. In the following description, the invention is set forth in the context of specific examples and user interface screens related to an NDA implementation. However, it will be appreciated that the invention is not limited to these examples, interfaces, or implementation. Accordingly, the following description should be understood as exemplary and not by way of limitation.

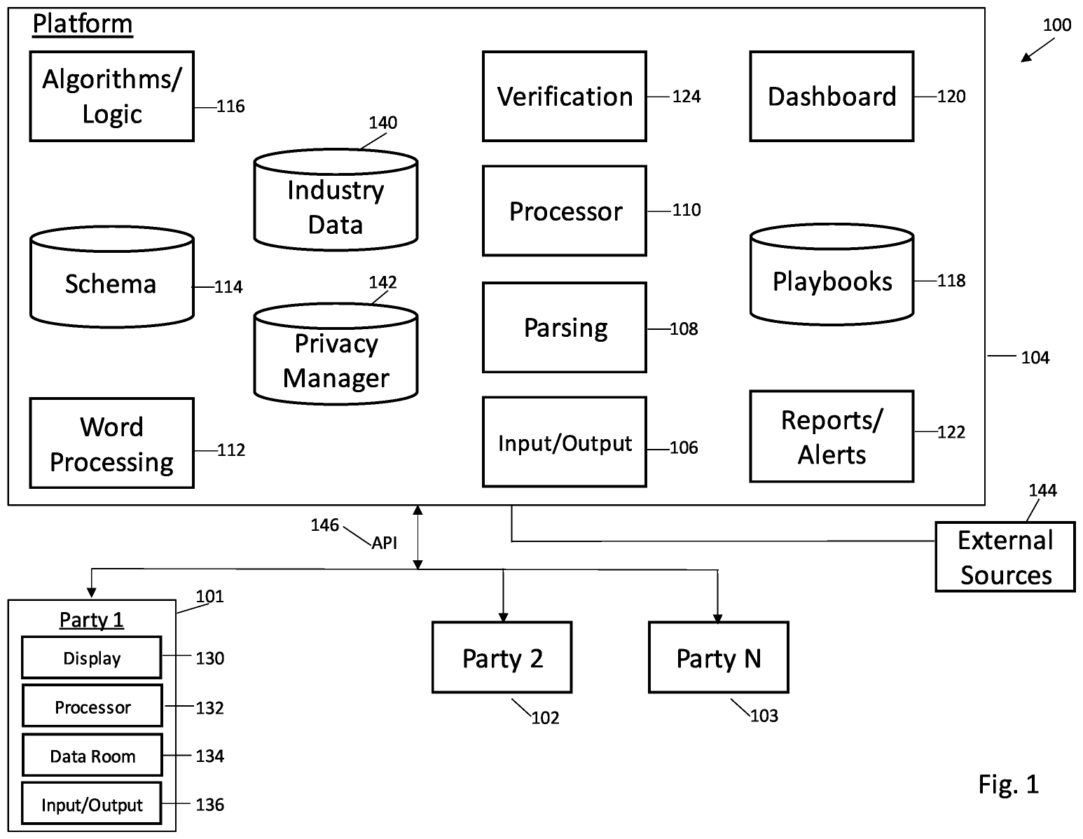

Referring to FIG. 1, a system for generating, negotiating, analyzing, and monitoring NDAs is identified by reference numeral 100. The system 100 includes a platform 104 that can be accessed by a number of parties 101-103. In this regard, individual parties 101-103 may access the platform 104 to build a playbook, to generate an NDA, to submit an NDA for analysis, or to monitor existing NDAs, among other things. Similarly, multiple parties 101-103 may access the platform 104 to negotiate a new NDA. Such parties may have an existing playbook or may be invited to develop a playbook in connection with negotiations as will be described below.

As noted, many parties 101-103 may access the platform 104. The parties 101-103 may access the platform 104 from a data terminal via a network, e.g., a public network such as the Internet. The individual data terminals of the parties 101-103 may be, for example, a smart phone, a tablet computer, a laptop or other personal computer, or any other computer-based terminal. The data terminals may execute an application for interfacing with the platform 104, e.g., an application or logic downloaded from the platform 104, or may be dumb terminals. Although three parties 101-103 are shown, it is anticipated that many parties may access the platform 104. Indeed, the large number of participating parties, as well as NDA information from external sources 144, will enable the platform 104 to have exceptional access to NDA data to develop analytics and identify industry standards with fine resolution in relation to industries and contexts.

As will be described in more detail below, the data terminals of the parties 101-103 communicate with the platform 104 to implement a variety of functionality. Although the platform 104 is illustrated as a single platform 104, it will be appreciated that the platform 104 may be executed on one or more machines (e.g., computers or servers) at a single site or geographically distributed. Each such site may execute the full functionality of the illustrated platform 104 or the functionality may be distributed across sites. Moreover, the functionality may be distributed in various ways between the platform 110, the data terminals of the parties 101-103, and other platforms (for example, external data room platforms or document execution systems), e.g., some preprocessing of input information may be executed at the data terminals of the parties 101-103, for example, to facilitate rapid response or reduce use of processing resources of the platform 104 or communication bandwidth requirements and the logic 116 may be distributed between the platform 104 and the terminals of the parties 101-103. The platform 104 may be hosted at the location of the provider of the system 100 or may be implemented separately (e.g., cloud-based) and connected to an operator as well as to the parties via appropriate interfaces such as APIs 146. Such APIs may define a variety of interface elements, such as message types, data formats, fields and parameter values, metadata definitions, and the like.

Examples of components of a data terminal of a party 101 are shown in FIG. 1. Although the components are only illustrated in relation to party 101, similar components may be provided in connection with the data terminals of each of the parties 101-103. The illustrated terminal includes a display 130, a processor 132, a data room 134, and an input/output module 136. The display 130 displays NDA documents and various party interfaces as described herein. The input/output module 136 is operative for communicating with the corresponding component 106 of the platform 104. In this regard, the module 136 may format and otherwise process signals transmitted between the terminal of the party 101 and the platform 104 in accordance with the API 146 that defines formats, protocols, and other parameters of such communications. The processor 132 runs logic such as an application stored on the data terminal for executing the functionality for generating, negotiating, analyzing, and monitoring NDAs as described herein. The processor 132 further controls the display 130 and is operative for accessing information from the data room 134. The data room 134 includes storage for storing documents and other files associated with a project or an NDA. Although illustrated as being resident on the data terminal of party 101, it will be appreciated that the data room 134 may be externally hosted on a data room platform or the like.

The platform 104 includes an input/output module 106 operative for communicating with the data terminals of the parties 101-103 and other devices and platforms accessed by the system 100. In this regard, the module 106 is operative to ingest information from incoming communications and to process outgoing communications in accordance with an API or other messaging protocols. The parsing module 108 parses incoming communications to extract and enrich the data. Thus, for example, the module 108 may parse the communications into data chunks and associate the chunks with metadata identifying, for example, fields of information or attribute/value pairs defined by a schema 114.

Module 112 is operative to perform a variety of word/language processing functionality in relation to incoming or outgoing messages. Thus, for example, the module 112 may be operative to automatically insert text into an NDA or red-line a document or a provision. In this regard, if a party elects to replace or propose replacement of a first version of a provision with a second version of the provision, the module 112 may automatically insert the second version of the provision into the NDA and generate a red-line version comparing replacement provision to the original. The module 112 may also execute natural language processing to analyze strings of written or spoken text and to convert such text into structured data elements for further processing by the algorithm/logic 116.

The schema database 114 stores information defining a schema for the system 100. The schema 114 includes the elements necessary to define structured data for a given environment or context, such as processing of NDA information. In this regard, the schema may define, for example, categories of NDAs, NDA provisions, options for the various NDA provisions, parties, specific NDA projects, attributes and values, field descriptions, and any other information useful to describe the types of information used by the system 100 and to enable comparisons or other processing of data. The elements of the schema 114 may be reflected in tags or other metadata associated with chunks of information such as examples of provisions, language segments for inclusion in provisions, and the like.

The algorithm/logic 116 can be used to provide a variety of functions in the system 100. For example, the logic 116 can be used to analyze a source document such as a source NDA provided by a party 101-103, or from an external source 144, to identify individual portions of the source document and associate those portions with the corresponding elements of the schema 114 such as, for example, NDA-type, provision type, provision options, and the like. This may be done to develop a playbook for a party, to enable a negotiation process, to enable a third-party NDA analysis, or a monitoring process. A variety of types of algorithms and logic may be utilized by the module 116. For example, the module 116 may implement an algorithm 116 or machine learning/artificial intelligence logic. Various algorithms may be used, for example, to associate provisions of a source NDA with existing provision options, to compare edits from one party to another party's playbook, to match NDA provisions from playbooks of different parties 101-103, or to process sample NDA documents from a community to enrich a library of NDA provisions and options (which may be stored in industry database 140 as described below). Machine learning or artificial intelligence logic may be used to learn to recognize NDA provisions and options, to interpret language from source documents, to provide increased accuracy of matching logic used to match provisions during negotiations, or to learn how to select compromise provisions when parties to a negotiation have different preferences, among other things.

In the context of negotiations, the module 116 may attempt to generate an NDA that includes terms that are likely to be acceptable to all parties of the negotiation. Thus, for example, where the parties agree that a particular provision option is the most preferred option, that provision may be included in a proposed NDA document. Where the parties do not agree, a variety of rules or other logic may be employed. For example, if one provision option is deemed unacceptable by any of the parties, that option may be eliminated from consideration. If all of the provision options are unacceptable to one or more parties, an error message may be generated or common language variations may be displayed for the parties' consideration. Further, where the parties do not agree on preferences concerning a given provision, the module 116 may attempt to determine a provision option most likely to be acceptable to all parties. This may be a provision that has the highest cumulative preference value for all parties, the highest weighted preference value as determined by considering preferences together with priorities concerning that provision for each of the parties, a high level of acceptance in the industry or context, or the like. In general, it is expected that the module 116 will be configured to develop the proposed NDA without bias in relation to the parties though the preferences of one or another of the parties may be favored for particular provisions based on, for example, a priority associated with that provision by one of the parties or a statistical or other analysis employed to generate an NDA with a higher probability of being acceptable to the parties. For example, certain tiebreaker logic and algorithms may be implemented in relation to market standards or other playbook or negotiation parameters.

The playbooks database 118 stores one or more playbooks for each of the parties 101-103. As will be described in more detail below, a playbook generally includes a collection of NDA provisions, rankings, priorities, and other information that define preferences of a party in relation to a given NDA or type of NDA. In this regard, a party may have multiple playbooks for different NDA types (e.g., one-way or two-way) and different contexts (e.g., financial information for potential investors, financial information for financial institutions, technical information for a joint development partner, or technical information for a contract manufacturer). Each of the playbooks may be associated with an identifier so that in connection with initiating a specific process, such as generating, negotiating, analyzing, or monitoring an NDA, a party 101-103 can specify the playbook to be utilized. The database 118 may store these playbooks in a structured form where individual items of information are indexed to corresponding elements of the schema 114.

The illustrated platform 104 further includes a dashboard module 120. The module 120 is operative to generate information to display in the form of a dashboard on a display 130 of a party 101. Thus, for example, a party may configure a dashboard, using settings of an application, to display status information regarding, for example, all pending NDAs, all executed NDAs, all NDAs, all NDAs of a particular type, or the like. In addition, the party 101-103 may configure what fields of data to display in connection with each of the NDAs displayed on the dashboard. For example, such fields may include the status of the NDA, the expiration date of the NDA, the execution date of the NDA, the presence or absence of certain terms such as a non-solicitation clause, next required action, choice of law, and the like. Individual elements of the dashboard may be hyperlinked to sources of more detailed information concerning the information item.

The reports/alerts module 122 can be used to generate a variety of outputs in a variety of formats. For example, reports concerning the status of NDAs of a party 101-103 may be periodically generated and transmitted to a party 101-103, e.g., via an email, text, or other message. The full report may be transmitted to the party 101-103 or a link to the report may be transmitted to the party. Such reports may be configured by a party as described above in connection with the dashboard. In addition, alerts may be generated in connection with changes in status, deadlines, and required actions, among other things. For example, one or more parties may be notified when an NDA has been fully executed, when a reply is due in connection with negotiations, when an expiration date is approaching, when an action such as destruction of documents is required, or when another deadline is approaching. Such alerts may be provided by email, text, or other messaging mode.

The verification module 124 may include logic for executing a variety of verification functions. It will be appreciated that it may be useful to verify various actions in connection with monitoring an NDA. Such actions may include, for example, verifying destruction of documents including protected information, obtaining log files indicating who has accessed certain files and for what purpose, and verifying that all copies of documents including protected information include appropriate legends and attributions, among other things. The module 124 can obtain information concerning verification items from associated NDAs, determine appropriate verification processes, identify data rooms or other sources of verification information, and access such sources of verification information to verify compliance with NDA terms. It will thus be appreciated that the platform 104, in conjunction with data terminals of the parties 101-103, can execute a variety of functionality related to NDA generation, negotiation, analysis, and monitoring.

With regard to analysis, in some cases, a party 101-103 may wish to have a third-party NDA analyzed, e.g., to obtain a favorability or unfavorability rating, to identify unacceptable terms, to provide a synopsis, or verify compliance with company policies, among other things. In such cases, the target NDA may be uploaded (or otherwise accessed) and processed as described above. The target NDA may then be compared to industry data 140 compiled through analysis of NDA information uploaded by parties 101-103 and obtained from external sources 144. For example, an initial analysis may be performed with respect to the target NDA to determine the industry and context of the NDA as well as to analyze individual provisions as noted above. Then, based on the industry and context, individual provisions and/or the overall NDA may be scored in relation to industry standards. A report, e.g., including the score(s) and other information about the target NDA, may then be generated and transmitted to a recipient, e.g., the requesting party.

It will thus be appreciated that the platform 104 may access and process a large volume of NDA information from parties 101-103 and external sources 144 and that such information may be used in generating reports for parties 101-103 or other recipients. This knowledge base will be valuable and increase in value as the volume of NDA information in database 140 grows. However, it is also important to respect the privacy and business sensitivities of all those whose NDA information is utilized. In this regard, the privacy manager 142 can control how NDA information is stored, used, and shared. The privacy manager 142 may obtain permissions, opt-ins, opt-outs, and the like as required or desired by relevant government entities, administrative bodies, jurisdictions, or industry/company policies. In addition, privacy manager 142 may implement entity-specific rules based on preferences or policies. To manage how information is stored, used, and shared, privacy manager 142: may mark NDA information as private, public, or semi-private; may anonymize or aggregate NDA information to address privacy/sensitivity; may access entity-specific rules concerning storage, use, and dissemination; may redact specified information; and or may define sharing zones for a specific NDA or in general, among other things. The privacy manager also protects playbooks against access by the opposing party or others.

Thus, the privacy manager 142 develops and respects many privacy realms relating to individual entities, entities involved in a negotiation or transaction, or others. The system can thereby function as a trusted intermediary in negotiation and other contexts and can bring to bear information that would not be available to any party acting alone.

The system may perform additional functions and generate other types of reports. For example, based on collected market information, the system may report to users on the state of the market. This may include what the current state of the market is with respect to practices and specific provisions, emerging trends, and the like. The system may also generate periodic reports for a user, not necessarily in response to a concurrent request, concerning the user's use of the system as well as certain efficiency/performance metrics.

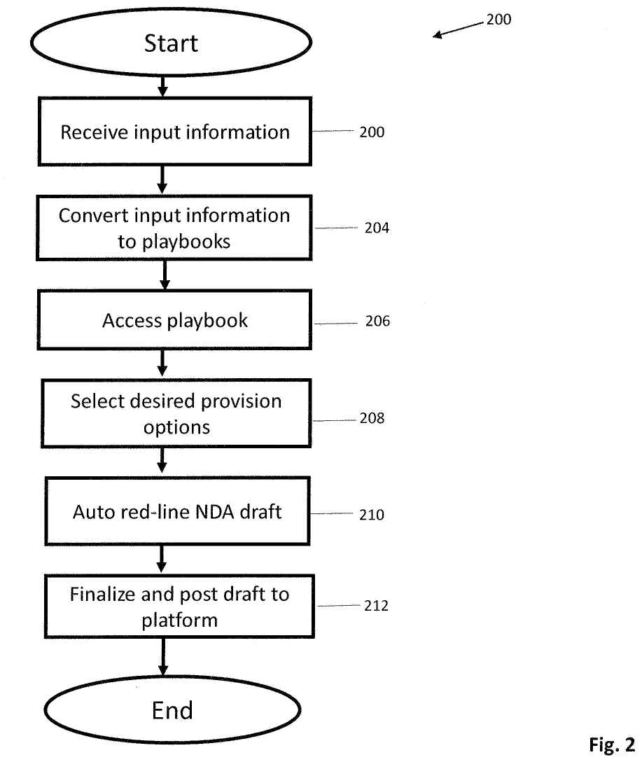

FIG. 2 is a flowchart illustrating a process 200 for generating an NDA in accordance with the present invention. The illustrated process 200 is initiated by receiving (202) information from a party. This information may be provided by the party in connection with registering with the platform or generating a playbook, which may occur well before it is desired to generate a particular NDA. The party may provide input information in connection with a preference survey administered by the system. Thus, for example, for each of a succession of NDA provisions, the party may be prompted to identify options that are acceptable and unacceptable as well as to rank each of the acceptable options in relation to preference for a particular playbook. Alternatively, a party may upload one or more NDAs to the platform or the platform may otherwise access one or more NDAs for the party. The platform can then execute logic to parse the source NDA documents into provisions and associate the provisions with preference options for the party to generate one or more playbooks based on inferred preferences.

The illustrated process further involves converting (204) the input information to one or more playbooks for a party. As noted above, the platform may receive or infer preference information in relation to various NDA provisions. This preference information can be used to generate a playbook that records information concerning what options are acceptable and unacceptable, rankings of acceptable options, priorities with respect to different provisions and the like all indexed to specific provisions. The playbook can be used in connection with a variety of functionality relating to generating, negotiating, and monitoring NDAs.

In the illustrated process 200 the playbook can be used to select (208) desired provision options. In this regard, the platform may generate a default NDA including the top ranked provision options for each provision. Alternatively, the party may be prompted to identify, for example, from a pulldown menu or other list, the desired provisions for an NDA. The party may then be led through a process where the party can select desired provision options for each provision. Optionally, information from a playbook of the party may be presented in connection with this process to assist the party in selecting provision options in accordance with preferences or policies.

In some cases, the platform may automatically generate a red-line version (210) of a provision or NDA showing differences between the generated document and a base document. The base document may be a default NDA of the party, a highest-ranking provision option, or another provision or document selected by the party as a baseline document. The party can review the red-line draft and finalize (212) the NDA. For example, this process may be implemented to generate a hard copy NDA for transmission to a counterparty independent of the platform, to generate a new base document to be stored at the platform, or to generate a proposed NDA for transmission to a counterparty via the platform. In certain cases, the finalized NDA may therefore be posted to the platform, e.g., designated for processing and/or storage at the platform.

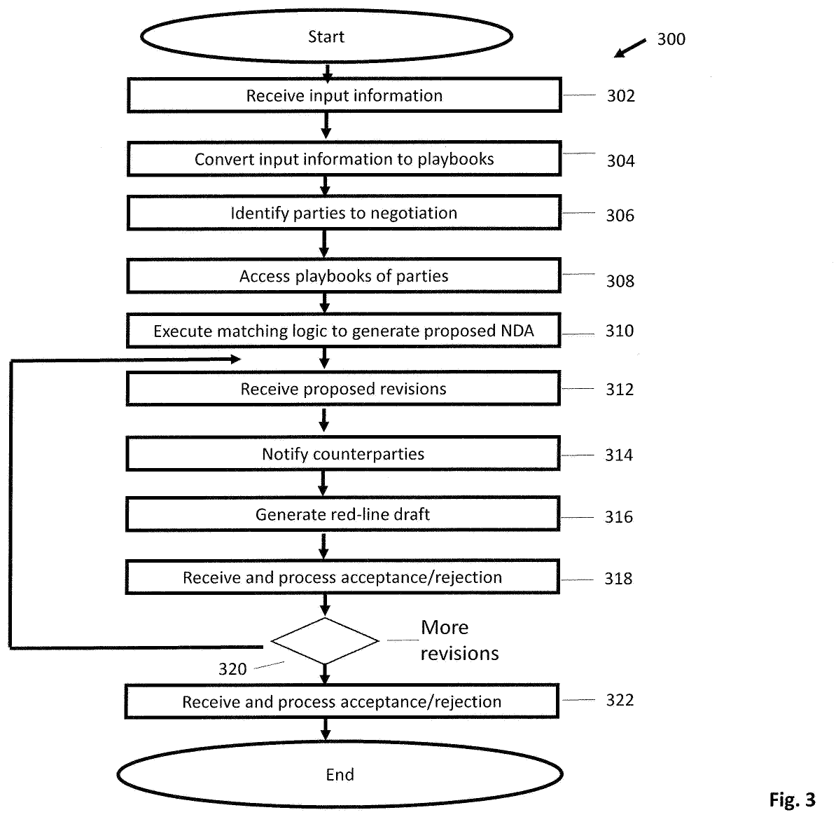

FIG. 3 shows a process 300 for negotiating an NDA in accordance with the present invention. The illustrated process 300 may begin by receiving (302) input information and converting (304) the input information into one or more playbooks as described above in connection with FIG. 2. The process 300 then proceeds by identifying (306) the parties involved in a particular negotiation. In a typical case, an NDA negotiation will involve two parties but more than two parties may be involved. The parties may be identified in connection with an authorization process for a given project. Thus, for example, one party may log into the system and invite a counterparty to join the negotiation or the system may otherwise generate email or other invitations with links to access the system/negotiation. The first party may specify a name for the NDA project and other information such as the nature of the NDA and subject matter involved. In addition, the first party may enter information concerning any terms and other matters that have been agreed to by the parties, e.g., in a letter of intent, such as the term of the NDA, the type of information to be protected, and allowed uses of the protected information. The platform may provide a template for entering such information. The first party may also identify the counterparty. The platform may then contact the counterparty to obtain authorization to initiate the negotiation as well as to obtain approval of any pre-approved terms and other matters that have been designated by the first party.

Once the parties have been identified, the system may access (308) appropriate playbooks of the parties. As noted above, a party may have multiple playbooks for different NDA types and contexts. Accordingly, the appropriate playbooks may be explicitly identified by the parties or inferred from the context of the NDA as indicated by an authorization process or template, or the system may transmit a query to a party prompting the party to identify the appropriate playbook.

The system may then execute (310) matching logic to generate a proposed NDA. As noted above, this may involve selecting provision options where the parties agree with respect to preferences, selecting a provision option most likely to be acceptable to both parties where the parties do not agree, or displaying common language variations where the parties do not agree, among other options. The proposed NDA may be forwarded to the parties or the parties may be notified that the proposed NDA is available for review.

The parties may then review the proposed NDA and accept the NDA or propose revisions to one or more provisions of the proposed NDA. This may involve proposing replacement of a provision with a different provision option or manually entering proposed revised text. In either case, the proposed revisions are received (312) at the platform, the other party is notified (314) of the proposed revisions, and a red-line version of the provision or NDA may be automatically generated (316). The other party may accept, reject, or revise the proposed changes and notification in this regard is received (318) by the platform. Again, the first party may be notified concerning such acceptance, rejection, or proposed revision. If additional changes are desired, the process may be repeated. Otherwise, the finalized NDA is sent (322) to both parties for execution. For example, this may involve an online execution process within the platform. Optionally, a third-party execution service, such as DocuSign™, may be utilized.

In cases where one party has a playbook and the other (guest) does not, proposed changes to a draft NDA by the guest may first be auto-matched against the first party's playbook to determine acceptability. In this regard, matching logic as noted above may compare the proposed revised text as proposed by the guest against provision options deemed acceptable in accordance with the first party's playbook. If a match is found, the proposed changes may be accepted without the need for the first party to manually review the proposed changes, thus yielding substantial efficiencies. Otherwise, the negotiation process may proceed as described above.

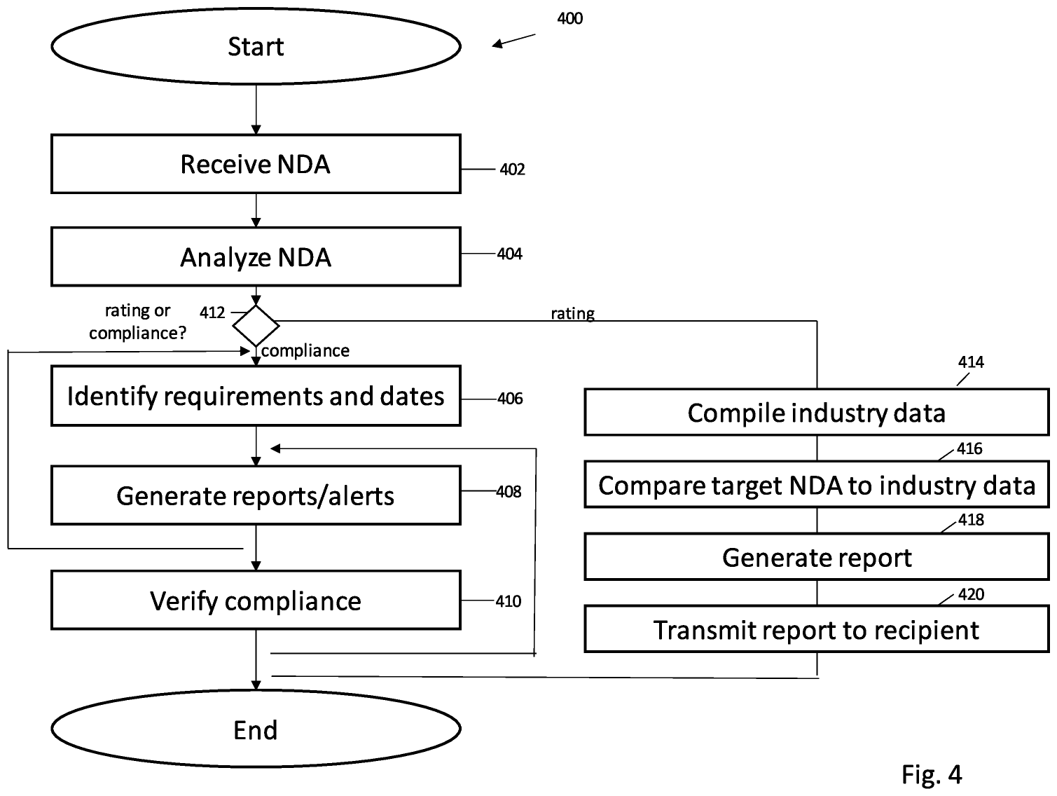

FIG. 4 illustrates a process 400 for analyzing NDAs and verifying compliance with terms of an NDA. As noted above, there are various provisions of an NDA where verification of compliance may be desired. These include, for example, destruction of documents containing protected information after termination of the NDA, monitoring who accesses the protected information and for what purpose, and verifying that all documents including protected information include required legends or attributions. The illustrated monitoring process 400 is initiated by receiving (402) an NDA for which monitoring is desired. If the NDA was generated by the system, a party may simply identify the NDA which may already be stored at the system platform. Alternatively, a party may upload an NDA to the system platform.

In either case, the NDA is then analyzed (404) to identify (406) matters that may require monitoring. As noted above, the various provisions of an NDA as well as any included attributes (e.g., term, effective date, termination date, document destruction provisions, required legends and attributes, etc.) and values (dates, time periods, required legends, identification of permitted parties, identification of permitted uses, etc.) may be associated with the corresponding elements of a schema and identified by corresponding metadata. Accordingly, the system can identify events requiring monitoring as well as the required verification parameters and may proactively generate (408) reports or alerts summarizing such matters to be monitored. When triggering events occur, the system can access sources of verification information, such as data rooms, and execute appropriate processes to verify (410) compliance with NDA provisions. This may result in destruction or removal of documents from data rooms, generating reports or alerts identifying potential failures to comply with NDA terms, or other corrective measures.

In other cases, an NDA may be analyzed and rated in relation to specified criteria, industry standards, and/or policies of an entity. For example, a system user may submit an NDA received from a vendor or potential partner for analysis in relation to industry standards for NDAs in a particular context. In this regard, the system may compile (414) industry data based on NDAs analyzed in the context of prior transactions and NDAs obtained from external sources, e.g., publicly available documents. This information may be continually analyzed to generate sample provisions and statistical information indexed by industry, provision, and context. The target NDA information can then be compared (416) to industry data, for example, to rank or score individual provisions as being favorable or unfavorable to a party (disclosing party, receiving party, vendor, financial institution, etc.) or as being standard or not standard in the industry. The per provision scores may be aggregated to provide a composite score or rating for a target NDA. A report may then be generated (418) and transmitted (420) to a recipient. For example, the report may include an overall rating of the target NDA, per provision comments, and/or alerts or warnings concerning certain terms. The report may be transmitted to a user, analyst, or other interested and authorized person.

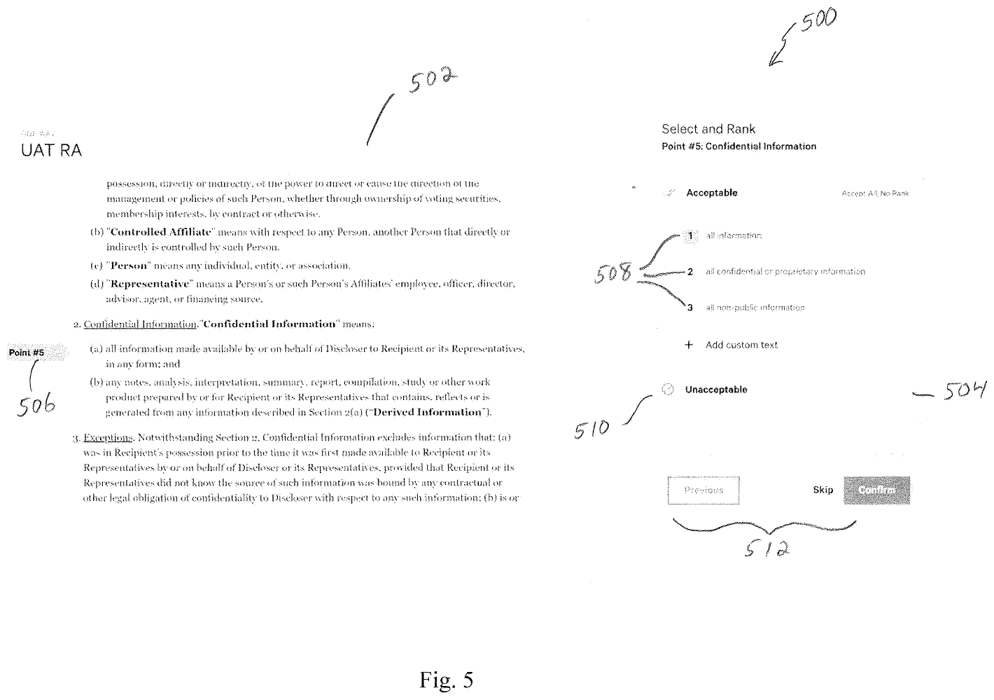

FIG. 5 illustrates a user interface screen 500 that may be displayed to a party in connection with a process for generating a playbook. The illustrated screen 500 includes a first panel 502 displaying NDA provisions and a second panel 504 for entering preference information. As shown, a cursor or prompt element 506 may sequentially advance, provision-by-provision, through a source document such as a default NDA. The default NDA may be, for example, a comprehensive NDA including substantially all the conventional provision types that may be included in an NDA. The provision options may be continually updated based on NDA documents submitted to the system platform as well as “market” data actively obtained by the system by harvesting example NDAs that are publicly available. When the element 506 advances to a particular provision, the panel 504 displays input elements for making selection options. For example, the party may use element 510 to indicate that a provision or provision option is acceptable or unacceptable. If the provision is acceptable, the party may use elements 508 to rank provision options or add customized text. If desired, more complex logic may be implemented. For example, Boolean operators may be employed to indicate that a particular provision option is unacceptable or preferred if other options have been selected (e.g., in connection with other provisions). Navigation elements 512 allow the party to navigate through the process, e.g., by skipping a provision, confirming selections, or returning to a previous screen or provision.

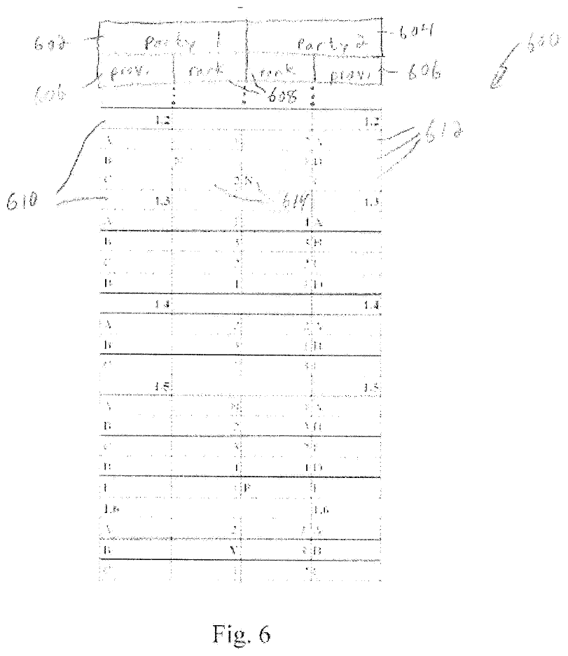

FIG. 6 graphically depicts, in the form of a table 600, information that may be used in comparing playbooks in a negotiation process. The table 600 includes playbook information for a first party 602 and a second party 604. For each of the parties, the table includes columns identifying provisions 606 and rank information 608 for those provisions. Thus, cells 610 identify successive provisions and cells 612 identify provision options. In connection with the provision options 612, cells 614 identify preference information such as whether the particular option is acceptable or unacceptable and rank information for each option. This information can then be used to select an option that is most likely to be acceptable to both parties 602 and 604. For example, in connection with provision 1.2 in the illustrated table 600, it would be expected that option “A” would be selected because 1) both parties had a high ranking for that option and 2) one party or the other identified options “B” and “C” as being unacceptable. In cases where only one of the parties has a playbook, the system may either generate a playbook for the other party, e.g., by prompting the other party to upload a sample NDA, or may receive proposed edits from the other party and match the edits to the first party's playbook.

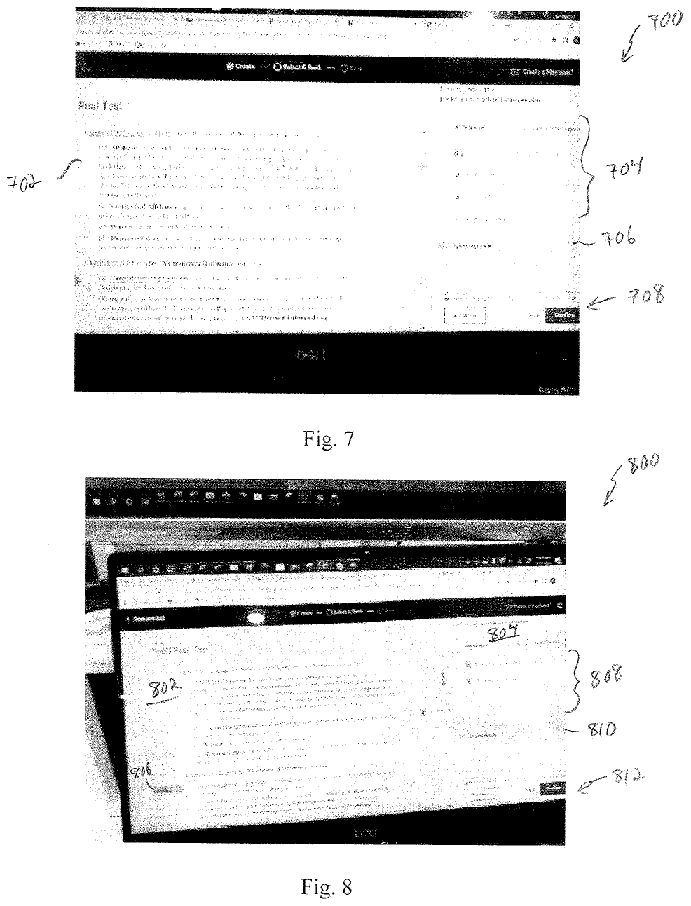

FIGS. 7-8 illustrate user interface screens 700 and 800 that may be provided in connection with a process of editing and generating real-time red-line documents. Each of the screens 700 and 800 includes a first panel 702 and 802 for displaying text of an NDA under consideration and a second panel 703 and 804 for use in entering editing selections. As discussed in connection with FIG. 5, the second panels 703 and 804 include preference options 704, 706, 808, and 810 and navigation elements 708 and 812. The screens 700 and 800 may also include a cursor or prompt element 806 identifying the provision to be edited. As shown in FIG. 7, the party can select a preference element 704 to execute an editing process. For example, by selecting a provision option 704 from the second panel 703, the party may replace the existing provision of panel 702 with the selected provision option 704 or language. For example, such replacement may be executed by a drag-and-drop process, sing radio buttons, or other operations and the text may then automatically appear in the NDA. As shown in FIG. 8, the system may automatically generate a red-line version of the edited provision in panel 802.

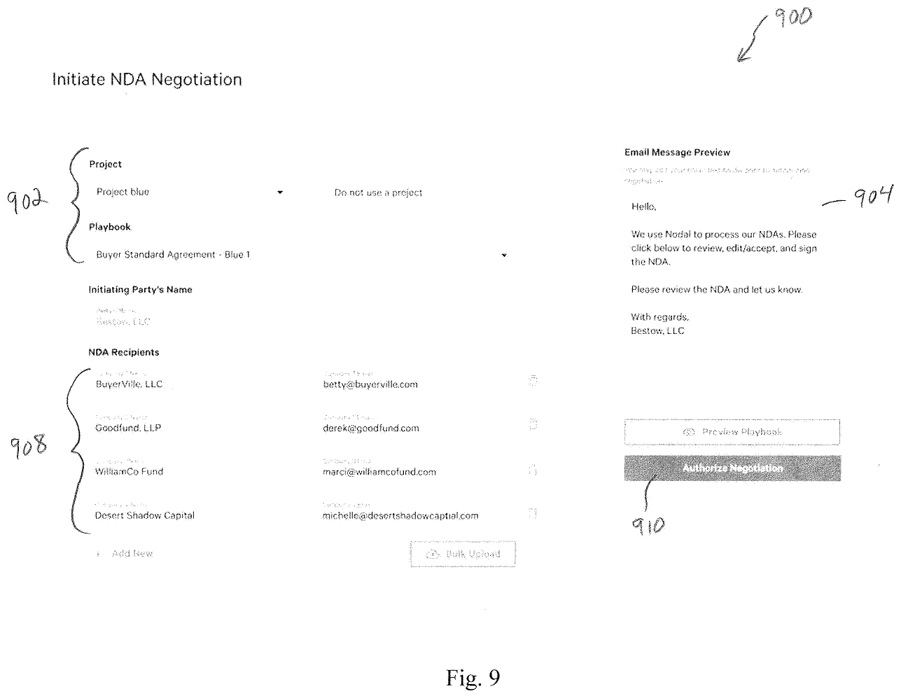

FIG. 9 illustrates a party interface screen 900 that may be displayed in connection with a process for initiating an NDA negotiation. Information may be entered into the screen 900 by one or both (all) of the parties. In the case where information is entered by one party, that party may specify via interface elements 902 the desired playbook for the project, a project name, and a purpose of the project, among other things. The illustrated screen 900 also includes a panel 904 for entering a message to be conveyed to the counterparties with the draft NDA. User interface elements 908 allow the party to enter information concerning the counterparty or counterparties for the negotiation and associated information such as contact information. When the user interface elements have been filled, the party may select the “Authorize Negotiation” button 910 to initiate the negotiations. This may result in the system contacting the counterparties to proceed with negotiations, e.g., by identifying existing playbooks or entering edits to an NDA generated from the playbook of the first party.

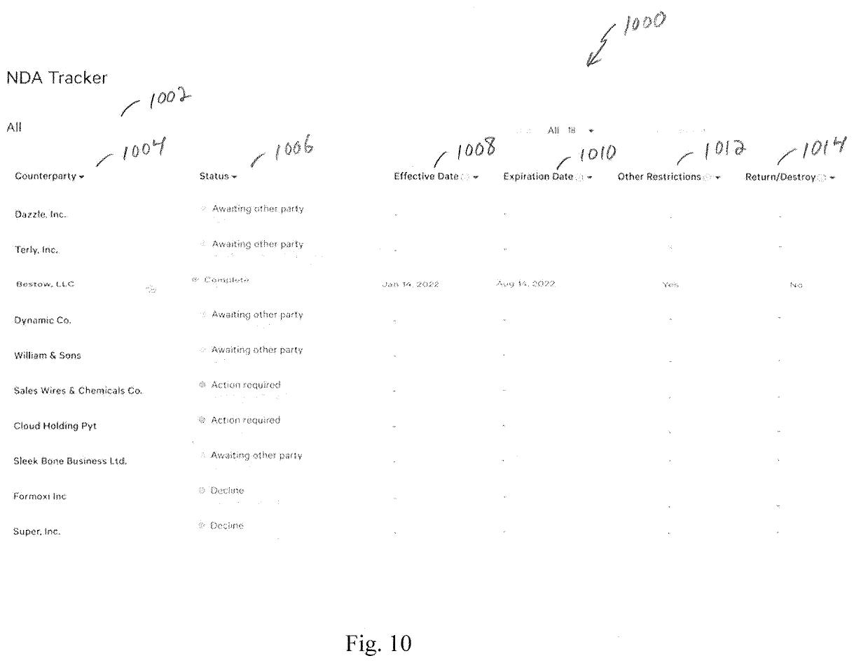

FIG. 10 shows a party interface screen 1000 that displays a dashboard for a party. As noted above, a party may provide settings or preferences for the dashboard identifying, for example, what NDAs to include in the dashboard and what fields of information. In the illustrated screen 1000, party interface element 1002 indicates that all NDAs of the party are included on the dashboard. Elements 1004, 1006, 1008, 1010, 1012, and 1014 illustrate various fields of information, in this case, the counterparty, the status of the NDA, the effective date where applicable, the expiration date where applicable, other provisions (e.g., whether the NDA includes a non-solicitation clause), and whether the NDA includes return/destroy provisions. It will be appreciated that many other fields are possible. The status field 1006 includes color-coded status information for both contracts in negotiation and executed contracts. Some or all of the information on the dashboard may be hyperlinked to source information, such as NDA contract provisions, to conveniently enable further inspection.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method for use in negotiating an agreement between opposing parties to the agreement, comprising:
establishing a computer-based platform for negotiating agreements, said platform being operated by an intermediary different from the parties to said agreements; and
operating said platform for:
receiving input information for each of multiple users;
converting said input information into playbooks for each of said multiple users, wherein each of said playbooks includes structured data structured according to a schema defining preference information concerning two or more provision options for each of multiple agreement provisions;
establishing a storage structure for said playbooks wherein each of said playbooks of said multiple users can be accessed by said intermediary but are inaccessible by one or more of said users different than an owner of each said playbook;
identifying at least first and second users as first and second parties for an agreement negotiation;
accessing a first playbook associated with said first party and second preference information for said second party;
executing matching logic to compare, on a provision-by-provision basis using said schema, said first playbook and said second preference information to generate a proposed agreement; and
obtaining execution of a finalized agreement by said at least first and second parties.

2. The method of claim 1, further comprising collecting, at said platform, a collection of said provision options for said multiple agreement provisions.

3. The method of claim 2, wherein said collecting comprises obtaining multiple versions of language for each of said multiple agreement provisions.

4. The method of claim 2, wherein said collecting comprises performing an analysis of multiple versions of language for each of said multiple agreement provisions and generating options based on said analysis.

5. The method of claim 2, wherein said input information comprises information from a survey completed by at least one of said multiple parties concerning preferences regarding said provision options.

6. The method of claim 2, wherein said input information comprises preferences for at least one of said multiple parties inferred from analysis of a source agreement document.

7. The method of claim 6, wherein said preferences are inferred by ingesting said source agreement document, converting said source agreement document into source structured data, and mapping elements of said source structured data to said schema.

8. The method of claim 1, wherein said second party is a guest and does not have a playbook, and said second preference information comprises proposed changes to one or more provisions of said proposed agreement.

9. The method of claim 8, wherein said matching logic is operative to compare said proposed changes to said first playbook of said first party to identify at least one of said proposed changes that is acceptable to said first party.

10. The method of claim 1, wherein said second preference information comprises a second playbook of said second party.

11. The method of claim 10, wherein said matching logic includes first logic for identifying matching provisions of said first and second playbooks and second logic for resolving a difference between said first and second playbooks for at least one of said multiple agreement provisions.

12. The method of claim 11, wherein said matching logic includes at least one of machine learning logic and a matching algorithm for resolving said difference.

13. The method of claim 1, further comprising receiving a proposed revision to said proposed agreement from said first party at said platform and operating said platform to notify said second party of said proposed revision.

14. The method of claim 13, wherein said receiving a proposed revision comprises providing a display including at least a portion of the proposed agreement in a first portion of the display and one or more alternative provision options in a second portion of said display, receiving an input from said first party in relation to desired provision of said alternative provision options, and replacing a subject provision of said proposed agreement with said desired provision.

15. The method of claim 14, wherein said input comprises dragging-and-dropping a graphical representation of said desired provision from said second portion of said display to said first portion of said display.

16. The method of claim 13, further comprising operating said platform to automatically generate a red-line version of said proposed agreement showing said proposed revision.

17. The method of claim 1, further comprising operating said platform to analyze said finalized agreement to identify one or more deadlines of said finalized agreement associated with one or more required actions.

18. The method of claim 17, further comprising providing a notification to said first party concerning said deadlines.

19. The method of claim 1, further comprising generating, for said first party, a dashboard including status information for multiple monitored agreements.

20. The method of claim 1, further comprising accessing a data room of said first party to certify compliance with one or more provisions of said finalized agreement.

21. A system for use in negotiating an agreement between opposing parties to the agreement, comprising:
a computer-based platform for negotiating agreements, said computer-based platform including an input module for receiving input information for each of multiple parties and a processor;
said processor being operative for:
converting said input information into playbooks for each of said multiple parties, wherein each of said playbooks includes structured data structured according to a schema defining preference information concerning two or more provision options for each of multiple agreement provisions;
identifying at least first and second parties for an agreement negotiation;
accessing first and second playbooks associated with said first and second parties;
executing matching logic to compare, on a provision-by-provision basis using said schema, said first and second playbooks to generate a proposed agreement; and
obtaining execution of a finalized agreement by said at least first and second parties.

22. The system of claim 21, further comprising collecting, at said platform, a collection of said provision options for said multiple agreement provisions.

23. The system of claim 22, wherein said collecting comprises obtaining multiple versions of language for each of said multiple agreement provisions.

24. The system of claim 22, wherein said collecting comprises performing an analysis of multiple versions of language for each of said multiple agreement provisions and generating options based on said analysis.

25. The system of claim 22, wherein said input information comprises information from a survey completed by at least one of said multiple parties concerning preferences regarding said provision options.

26. The system of claim 22, wherein said input information comprises preferences for at least one of said multiple parties inferred from analysis of a source agreement document.

27. The system of claim 26, wherein said preferences are inferred by ingesting said source agreement document, converting said source agreement document into source structured data, and mapping elements of said source structured data to said schema.

28. The system of claim 21, wherein said matching logic includes first logic for identifying matching provisions of said first and second playbooks and second logic for resolving a difference between said first and second playbooks for at least one of said multiple agreement provisions.

29. The system of claim 28, wherein said matching logic includes at least one of machine learning logic and a matching algorithm for resolving said difference.

30. The system of claim 21, further comprising receiving a proposed revision to said proposed agreement from said first party at said platform and operating said platform to notify said second party of said proposed revision.

31. The system of claim 30, further comprising operating said platform to automatically generate a red-line version of said proposed agreement showing said proposed revision.

32. The system of claim 21, further comprising operating said platform to analyze said finalized agreement to identify one or more deadlines of said finalized agreement associated with one or more required actions.

33. The system of claim 32, further comprising providing a notification to said first party concerning said deadlines.

34. The system of claim 21, further comprising generating, for said first party, a dashboard including status information for multiple monitored agreements.

35. The system of claim 21, further comprising accessing a data room of said first party to certify compliance with one or more provisions of said finalized agreement.

36.-39. (canceled)
